(19) United States
(12) Patent Application Publication
(10) Pub. No.: US 2010/0029798 A1
(43) Pub. Date: Feb. 4, 2010

(54) Polyurethane Elastic Memory Material that Emits Nano-negative Ion Far Infrared Rays and a Method for Preparing the Same

(76) Inventor: Kwok Wah Yau, Hong Kong (HK)

Correspondence Address: ERIC HANSCOM, 7395 PORTAGE WAY, CARLSBAD, CA, 92011, US

(21) Appl. No.: 12/510,943

(22) Filed: Jul. 28, 2009

(30) Foreign Application Priority Data
Jul. 29, 2008 (CN) 200810135056.2

(51) Int. Cl. C08G 18/00

(52) U.S. Cl. 521/159; 521/155; 521/170; 521/172; 521/174

(57) ABSTRACT

A polyurethane elastic memory material that emits nano-negative ion far infrared rays and a method for preparing the same is disclosed. A nano-negative ion far infrared ray emitting additive that belongs to the Lianfuya Established Series is added to polyester and/or polyether polyol to create a polyurethane elastic memory foam material that emits negative ions at a rate of 3,000 negative ions/cm³ or more. The negative ions and far infrared rays provide for a positive effect in the treatment of many ailments.

### CROSS REFERENCE TO RELATED APPLICATIONS

This application claims the benefit of Chinese Patent Application 200810135056.2 filed on Jul. 29, 2008.

### STATEMENT REGARDING FEDERALLY SPONSORED RESEARCH OR DEVELOPMENT

This invention was not federally sponsored.

### BACKGROUND OF THE INVENTION

### Field of the Invention

This invention relates to the general field of polyurethane elastic memory foam material, and more specifically toward a polyurethane elastic memory material that emits nano-negative ion far infrared rays and a method for preparing the same. A nano-negative ion far infrared ray emitting additive that belongs to the Lianfuya Established Series is added to polyester and/or polyether polyol to create a polyurethane elastic memory foam material that emits negative ions at a rate of 3,000 negative ions/cm³ or more. The negative ions and far infrared rays provide for a positive effect in the treatment of many ailments.

Due to the rapid development of the global economy, today's population encounters pollution that causes many ailments. Negative ions in the air can help counteract these negative effects and generally improve the health of a population. As early as the end of the 19^{th} Century and the beginning of the 20^{th} Century, scientists have found the existence of negative ions in the air and confirmed their significance in biology. In fact, nano-negative ion far infrared rays play a very important role in improving the living environment of people. For example, Pierce J. Howard, PhD, author of “The Owners Manual for the Brain: Everyday Applications from Mind Brain Research” and director of research at the Center for Applied Cognitive Sciences in Charlotte, N.C., proved that negative ions increase the flow of oxygen to the brain resulting in higher alertness, decreased drowsiness, and more mental energy. While the positive effects of negative ions are known, the materials and methods for efficient distribution of nano-negative ion far infrared rays to individuals are not well known.

Thus there has existed a long-felt need for a material that is widely used in various aspects of life, such as furniture, clothing, vehicles, costumes, accessories, leisure produces, healthcare products, and toys for children, that are capable of effectively and efficiently emitting nano-negative ion far infrared rays.

### SUMMARY OF THE INVENTION

The current invention provides just such a solution by having a polyurethane elastic memory material that emits nano-negative ion far infrared rays and a method for preparing the same. A nano-negative ion far infrared ray emitting additive that belongs to the Lianfuya Established Series, also known as the Mason Established Series is added to polyester and/or polyether polyol to create a polyurethane elastic memory foam material that emits negative ions at a rate of 3,000 negative ions/cm³ or more. The nano-negative ion far infrared ray emitting additive is a natural opal shale mineral material having nano-pores that is drilled from 200 meters underground. A powder is created from the material through the use of high pressures and temperatures along with destruction of the mineral. It is this powder that is the nano-negative ion far infrared ray emitting additive used to create the polyurethane elastic memory material that emits nano-negative ion far infrared rays. The negative ions and far infrared rays provide for a positive effect in the treatment of many ailments.

Through our research, we have found that negative ions emitted from the product of “Lianfuya Established” series have a positive effect in the treatment of hypertension, asthma, influenza, arthritis, burns and the like. Further, the nano-negative ion far infrared rays emitted from the product of “Lianfuya Established” series is capable of preventing rachitis and scurvy, improving breathing by the lungs, assisting in metabolism, enhancing the body's natural immune system, assisting in deep sleep, reducing the frequency of turning over and waking up during sleep, alleviating body pain, shortening postoperative convalescence, remembering exterior structures of the human body, balancing different surface pressures of different individuals, absorbing kinetic energy and sound waves, adjusting function of the cerebral cortex, slowing sedimentation rate of the erythrocyte, and elongating blood coagulation time.

It is a principal object of the invention to provide a polyurethane elastic memory material that emits nano-negative ion far infrared rays.

It is another object of the invention to provide a method for preparing a polyurethane elastic memory material that emits nano-negative ion far infrared rays.

It is a final object of this invention to provide a material that is widely used in various aspects of life that have a positive effect in the treatment of many ailments.

There has thus been outlined, rather broadly, the more important features of the invention in order that the detailed description thereof may be better understood, and in order that the present contribution to the art may be better appreciated. There are additional features of the invention that will be described hereinafter and which will form the subject matter of the claims appended hereto. The features listed herein and other features, aspects and advantages of the present invention will become better understood with reference to the following description and appended claims. The accompanying drawings, which are incorporated in and constitute part of this specification, illustrate embodiments of the invention and, together with the description, serve to explain the principles of the invention.

### DETAILED DESCRIPTION OF THE INVENTION

The current invention is a unique combination of materials by a unique process to create a polyurethane elastic memory foam material that emits nano-negative ion far infrared rays. A preferable combination of substances to create this polyurethane elastic memory foam material is listed in Table 1, whereby the resulting polyurethane elastic memory foam material emits significantly more negative ions/cm³ than was possible before this invention.

TABLE 1
Percent Composition by Mass of Polyurethane Elastic
Memory Foam Material

| | |
|---|---|
| Polyester (hydroxyl value = 56) and/or Polyether polyol | 30%-80% |
| Diisocyanate | 25%-55% |
| Nano-far infrared negative ion additive | 2%-18% |
| Adjuvent | 1.5%-8% |
| Foaming agent | 0.5%-3% |
| Catalyst | 0.4%-2% |
| Mildew inhibitor | 0.1%-0.5% |
| Flame retardant | 5%-10% |

Polyester and/or polyether polyol (collectively “polymeric polyol”) combined with diisocyanate are common polymeric raw substances used to create polyurethane materials that are in conformity with international standards. These compounds can be either organic or inorganic. A particularly preferred embodiment includes between 50% and 70% polymeric polyol.

The nano-far infrared negative ion additive belongs to the Lianfuya Established series. The Lianfuya Established series is characterized by a natural opal shale mineral material having non-pores. This mineral is capable of emitting 5,000 negative ions/cm³ or more. However, when this mineral is combined together with the other substances listed in Table 1, the polyurethane elastic memory foam material emits 3,000 negative ions/cm³ or more. A particularly preferred embodiment includes between 2% and 5% nano-far infrared negative ion additive.

The adjuvant listed in Table 1 can be a softener, a colorant, a color fixative, a thickener, a humectant, an anti-scratching agent, a like substance, or any combination thereof. The foaming agent is preferably a physical or chemical foaming agent. The catalyst is preferably triethylene or diamine. The diisocyanate is an isocyanate that has two isocyanate groups.

The method for making the polyurethane elastic memory foam material involves adding the nano-far infrared negative ion additive, the adjuvant, the mildew inhibitor, the flame retardent and the catalyst to the polyester and/or polyether polyol. This is then reacted with an isocyanate (diisocyanate) to form the polyurethane elastic memory material. A particularly preferred embodiment includes 25-30% diisocyanate. The resulting polyurethane elastic memory foam material emits nano-negative ion far infrared rays.

In a particularly preferred embodiment, the substances listed in Table 2 are combined to create a polyurethane elastic memory foam material that emits nano-negative ion far infrared rays. The substances of Table 2 are combined and stirred for at least 45 seconds and no more than 90 seconds, and preferably about 60 seconds, and then formed into a mold. Using this preferred combination of substances using this method, it is possible to achieve 4,000 negative ions/cm³ of polyurethane elastic memory foam material.

TABLE 2
Substances by Mass Combined to Produce
Polyurethane Elastic Memory Foam Material

| | | |
|---|---|---|
| Polyether polyol | 400 | g |
| Diisocyanate | 187.5 | g |
| Nano-far infrared negative ion additive | 25 | g |
| Adjuvent | 10 | g |
| Foaming agent | 9.5 | g |
| Catalyst | 2.5 | g |
| Mildew inhibitor | 1.5 | g |
| Flame retardant | 40 | g |

The polyurethane elastic memory foam material can be used in variety of applications. It can be used as a mattress, pillow, seat cushion, or other furniture application. Vehicle or aircraft seats can comprise this material to provide comfort and beneficial nano-negative ion far infrared rays to the user. Uses can also include clothing, accessories, leisure produces, health care products such as hospital beds, and toys and other products for children, such as rocking horses and car seats.

In another preferred embodiment, a user puts 400 g of polyether polyol, preferably polyether glycol, and 187 g of diisocyanate in a room with constant temperature which is 20 degrees Celsius. The mixture is then allowed sufficient time to adjust to 20 degrees Celsius. Then the polyether polyol is put it into a mixing container. The mixer of the mixing container is started thereby stirring the mixture after pouring 10 g of adjuvant, 9.5 g of foaming agent, 2.5 g of catalyst, 1.5 g of mildew inhibitor, and 40 g of flame retardant into the mixing container. After stirring for 3 to 5 minutes, negative ion additive and far infrared additive in the amount of 25 g is added in to the mixture and stirring continues for 5 to 10 minutes. Then, polyether polyol, preferably polyether glycol, is poured into the mixing container and stirring continues for 3 seconds. The resulting mixture is then put into a prepared mold that renders foaming polymerization immediately. After the polymerization, it goes to a post curing process. The whole polymerization process takes about 3 minutes. The post curing time is around 2 hours, during which the temperature of the foam itself is increased to about 150 degrees Celsius. Then the well-formed foam body will be sent to a cutting process, and modified into varieties of finished product as required.

When used herein and describing percentages, “between” is inclusive of the boundary values such that “between 0% and 100%” includes both 0% and 100%.

It should be understood that while the preferred embodiments of the invention are described in some detail herein, the present disclosure is made by way of example only and that variations and changes thereto are possible without departing from the subject matter coming within the scope of the following claims, and a reasonable equivalency thereof, which claims I regard as my invention.

All of the material in this patent document is subject to copyright protection under the copyright laws of the United States and other countries. The copyright owner has no objection to the facsimile reproduction by anyone of the patent document or the patent disclosure, as it appears in official governmental records but, otherwise, all other copyright rights whatsoever are reserved.

What I claim is:

1. A polyurethane elastic memory foam material comprising, by mass, between 2% and 18% nano-far infrared negative ion additive.

2. The polyurethane elastic memory foam material of claim 1, further comprising, by mass, between 30% and 80% polymeric polyol.

3. The polyurethane elastic memory foam material of claim 2, wherein the polymeric polyol is polyester.

4. The polyurethane elastic memory foam material of claim 2, wherein the polymeric polyol is polyether polyol.

5. The polyurethane elastic memory foam material of claim 1, further comprising, by mass, between 25% and 55% diisocyanate.

6. The polyurethane elastic memory foam material of claim 1, wherein the nano-far infrared negative ion additive belongs to the Lianfuya Establised series.

7. The polyurethane elastic memory foam material of claim 1, wherein the polyurethane elastic memory foam material emits 3,000 negative ions/cm³ or more.

8. The polyurethane elastic memory foam material of claim 1, further comprising, by mass, between 1.5% and 8% adjuvant, between 0.5% and 3% foaming agent, between 0.4% and 2% catalyst, between 0.1% and 0.5% mildew inhibitor, and between 5% and 10% flame retardant.

9. The polyurethane elastic memory foam material of claim 8, wherein the adjuvant is selected from the group consisting of: a softener, a colorant, a color fixative, a thickener, a humectant, and an anti-scratching agent.

10. The polyurethane elastic memory foam material of claim 8, wherein the foaming agent is selected from the group consisting of a physical foaming agent and a chemical foaming agent.

11. The polyurethane elastic memory foam material of claim 8, wherein the catalyst is selected from the group consisting of triethylene and diamine.

12. A method for making a polyurethane elastic memory foam material comprising the steps of combining, by mass, between 30% and 80% polymeric polyol and between 2% and 18% nano-far infrared negative ion additive with between 25% and 55% diisocyanate, and then pouring the resulting mixture into a mold.

13. The method of claim 12, wherein the step of combining is performed by stirring the polymeric polyol and nano-far infrared negative ion additive with the diisocyanate.

14. The method of claim 12, wherein between 1.5% and 8% of adjuvant, between 0.5% and 3% of foaming agent, between 0.4% and 2% catalyst, between 0.1% and 0.5% mildew inhibitor, and between 5% and 10% flame retardant, all by weight, is combined with the polymeric polyol and nano-farinfrared negative ion additive.

15. The method of claim 12, wherein the nano-far infrared negative ion additive belongs to the Lianfuya Establised series.

16. The method of claim 12, wherein the resulting polyurethane elastic memory foam material emits 3,000 negative ions/cm³ or more.

17. The method of claim 12, wherein the resulting polyurethane elastic memory foam material emits 4,000 negative ions/cm³ or more.

18. A polyurethane elastic memory foam material comprising, by mass, between 50% and 70% polyether polyol, between 25% and 30% diisocyanate, and between 2% and 5% nano-far infrared negative ion additive.

19. The polyurethane elastic memory foam material of claim 18, wherein the nano-far infrared negative ion additive belongs to the Lianfuya Establised series.

20. The polyurethane elastic memory foam material of claim 18, further comprising, by mass, between 1.5% and 8% adjuvant, between 0.5% and 3% foaming agent, between 0.4% and 2% catalyst, between 0.1% and 0.5% mildew inhibitor, and between 5% and 10% flame retardant.
